(19) United States
(12) Patent Application Publication
(10) Pub. No.: US 2015/0301705 A1
(43) Pub. Date: Oct. 22, 2015

(54) METHOD FOR DISPLAYING PDF FILE

(71) Applicant: Fujian Foxit Software Development Joint Stock Co., Ltd., Fuzhou (CN)

(72) Inventor: Huarong Li, Beijing (CN)

(21) Appl. No.: 14/440,184

(22) PCT Filed: Oct. 23, 2013
(86) PCT No.: PCT/CN2013/001281

§ 371 Date: May 1, 2015

(30) Foreign Application Priority Data
Nov. 2, 2012 (CN) 201210433843.1

(51) Int. Cl. G06F 3/0483; G06F 3/0484

(52) U.S. Cl. CPC G06F 3/0483; G06F 3/04842

(57) ABSTRACT

The present invention relates to a method for displaying a PDF file. The method comprises: step 1: extracting the number of pages of a PDF file step 2: displaying a cubic model book by using a three-dimensional manner, and making the thickness of the model book directly proportional to the number of the pages of the PDF file step 3: determining whether page turning is required, and if yes, performing step 4 and step 5 successively, otherwise, performing step 6 step 4: receiving the number of a page to be turned to step 5: turning pages of the model book by using the three-dimensional manner, wherein a displayed page after the page turning is ended is a page whose number is equal to the number of the page turned to in the PDF file, the thickness of turned pages of the model book is directly proportional to the number of the page turned to, and the thickness of unturned pages of the model book is directly proportional to a difference obtained by subtracting the number of the page turned to from the number of pages of the PDF file and step 6: returning to step 3. By means of the present invention, the user experience in reading a DPF file can be improved.

### TECHNICAL FIELD

The present invention relates to a technical field of displaying a PDF (portable document format) file, in particular, relates to a method for displaying a PDF file.

### BACKGROUND

To date, PDF files displayed by a PDF reader are all in a planar pattern, that is, the pages in the PDF files are displayed in a form of a single sheet on the desktop. Therefore, if pages are to be turned, the pages must be dragged by a mouse or other hard objects such as a finger so as to touch the screen in a dragging style. This technology is relatively monotonous, and relatively poor in user experience.

### SUMMARY OF THE INVENTION

The technical problem solved by the present invention is to provide a method for displaying a PDF file so as to improve the user experience for reading PDF files.

A technical solution of the present invention for solving the above technical problem is as follows: A method for displaying a PDF file, comprising

Step 1: extracting and obtaining a total value of pages of the PDF file;

Step 2: displaying a cubic model book corresponding to the PDF file three-dimensionally, so that the thickness of the cubic model book is proportional to the total value of the pages of the PDF file;

Step 3: Determining whether it is demanded to turn pages of the PDF file or not, if “yes”, then step 4 and step 5 are performed sequentially, otherwise step 6 is performed;

Step 4: receiving a page number to be turned to;

Step 5: turning page(s) of the cubic model book three-dimensionally, so that: after finishing turning page(s), a page in the PDF file is displayed, wherein, the page number of the displayed page in the PDF file is equal to the page number which has been turned to, and the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file;

Step 6: Return to the step 3.

The beneficial technical effect of the present invention is in that: in the present invention, a PDF file is displayed in the form of a cubic model book three-dimensionally, wherein, the thickness of the cubic model book is alterable, and is proportional to the total value of pages of the PDF file. If a user need read a PDF file, he can turn the pages three-dimensionally by typing the page number to be turned to in the cubic model book, so as to turn to the page the user wants to reach. The thickness of page(s) which has/have been turned over in the cubic model book is proportional to the page number which has been turned to, and the thickness of page(s) which has/have not been turned over is proportional to a difference value calculated by subtracting the page number which has been turned to from the total value of the pages of the PDF file. Thus it can be seen that, the static presence sense in the form of the cubic model book and the dynamic sense of turning page(s) three-dimensionally can be experienced by the user. This technique has a good user interface, and a strong human-computer interaction sense, and thus has great attraction for the readers, so that it greatly improves the user experience of reading PDF files.

Based on the above technical solution, the present invention can also be improved by the following method:

Further, after the step 2, prior to the step 3, further comprising:

Step 2-1: Determining whether a virtual light source is demanded or not, if yes, then step 2-2 and step 2-3 are performed sequentially, otherwise step 3 is performed;

Step 2-2: receiving position information of the virtual light source;

Step 2-3: Setting a virtual light source at the position indicated by the position information of the virtual light source, a light emitted from the virtual light source project onto the cubic model book, so that the cubic model book forms a shadow in the backlight direction.

Further, the step 2-2 further comprising: receiving color information of the virtual light source; and thus,

In the step 2-3, the color of the light of the virtual light source is determined according to the color information of the virtual light source.

Further, the step 2-2 further comprising: receiving illumination intensity information of the virtual light source; and thus,

In the step 2-3, the light intensity emitted from the virtual light source is proportional to the illumination intensity information of the virtual light source. Further, in the step 5, after a sub-step recited as: “after finishing turning page(s), a page in the PDF file is displayed, wherein, the page number of the displayed page in the PDF file is equal to the page number which has been turned to, and the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file”, the method further comprises the following sub-steps:

Sub-step 5-1: Determining whether it is demanded to rotate or not, if “yes”, then Sub-step 5-2 and Sub-step 5-3 are performed sequentially, otherwise there is not any operation;

Sub-step 5-2: receiving rotation angles to be rotated in each direction in a three-dimensional coordinate system;

Sub-step 5-3: Rotating the cubic model book, so that, in the three-dimensional coordinate system, the cubic model book has been rotated angles in each direction which are equal to the rotation angles to be rotated in the same direction.

### DESCRIPTION OF THE DRAWINGS

FIG. 1 is a flow diagram of the method for displaying a PDF file according to the present invention.

### DETAILED DESCRIPTION OF THE EMBODIMENTS

With reference to the accompanying drawing, the description of the principles and features of the present invention are given as follows. The given embodiments are only applied to explaining the present invention, but not be applied to limit the scope of the present invention.

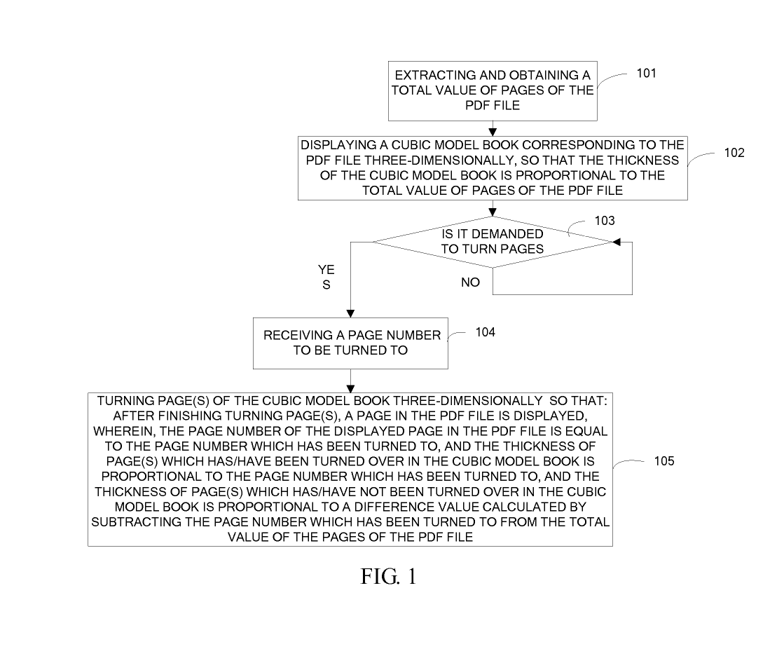

FIG. 1 is a flow diagram of the method for displaying a PDF file according to the present invention. As shown in FIG. 1, the method comprises:

Step 101: extracting and obtaining a total value of pages of the PDF file.

“PDF” is an acronym for “Portable Document Format”, which means an electronic file format. PDF files refer to electronic documents in PDF format.

Information in PDF files is saved in the way of page by page; therefore, each PDF file has a certain total value of pages. In prior art, each page of the PDF file is displayed by dragging a mouse or touching a screen in the dragging style with other hard objects such as a finger so as to display pages of the PDF file sequentially.

Step 102: displaying a cubic model book corresponding to the PDF file three-dimensionally, so that the thickness of the cubic model book is proportional to the total value of pages of the PDF file;

In the present invention, the PDF file are displayed three-dimensionally, a corresponding image of which displayed on the display device is a cubic model book, wherein the cubic model book has a length, a width and a thickness, therein the thickness is proportional to the total value of pages of the PDF file extracted and obtained in step 101, and its width and thickness can be predetermined.

Obviously, the PDF file is displayed as the cubic model book, so that the PDF file has a three-dimensional static presence sense, and a better user interface, improves the user's interest of reading the PDF file, and thus increases the user experience of reading the PDF file.

Step 103: Determining whether it is demanded to turn pages of the PDF file or not, if “yes”, then step 104 and step 105 are performed sequentially, otherwise goes back to perform the present step 103;

The cubic model book displayed in step 102 exists in the form of the static state, and can not display the content of the PDF file. If the user is intended to read the PDF file, it is naturally demanded to display the page content which the user wants to read. The present invention reaches the page specified by the user by turning pages, and thus prior to turning pages, it is necessary to determine whether it is demanded to turn pages, that is, whether readers has issued a page-turning instruction. If “yes”, it is demanded to turn pages, then turn to the page the reader wants to read by step 104 and step 105. Otherwise, it means that the reader does not want to read a page with a certain page number, therefore, the step 103 is re-executed to determine whether it is demanded to turn pages or not .

Step 104: receiving a page number to be turned to;

If the determination result in step 103 is “yes”, it means that the user wants to read a certain page in the PDF file, it is necessary to determine the page number the user wants to read. The “page number to be turned to” received in this step 104 is the page number corresponding to the page which the reader wants to read.

Step 105: turning the pages of the cubic model book three-dimensionally, so that: after finishing turning page(s), a page in the PDF file is displayed, wherein, the page number of the displayed page in the PDF file is equal to the page number which has been turned to, and the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file;

This step 105 is a three-dimensional page-turning step, the essence of which is turning over pages from the currently displayed page to the page indicated by the “page number to be turned to” received in this step 104. It is concerned in the following expression form that it is implemented three-dimensionally in this step 105; this can improve the page-turning dynamic sense, further it could improve the user experience of reading the PDF file.

In this step 105, the three-dimensional way of turning pages of the cubic model book could be that: all pages before the page indicated by the page number to be turned to in the PDF file would be turned over integrally, or that: all pages before the page indicated by the page number to be turned to in the PDF file would be turned over several times page by page, that is, one page is turned one time, and each page is turned separately and sequentially,

After finishing turning pages, the cubic model book is in an open state, wherein, the turned page(s) is/are on one side, and the unturned page(s) is/are on the other side, and the page currently displayed on the display device is the page indicated by the page number to be turned to. When the cubic model book is displayed in this step 105, the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file, corresponding to all pages except the page(s) which has/have been turned over. Thus the method can further humanize the present invention, and improve the realism sense for the user's reading.

The user can read the page indicated by the page number to be turned to on the display device after finishing turning page(s) in this step 105. If the page is not the page which the user wants to read, or the user finish reading the page which the user wants to read, it is demanded to further turn the pages. Thus after finishing the step 105, it is also possible to go back to perform step 103. Of course, after finishing the step 105, a new determination step may be provided: determining whether reading is done or not; if “yes” then the PDF file is closed, that is, the PDF file information is no longer displayed on the display device; otherwise, the new determination step is re-executed.

It can be seen that, in the present invention, the PDF file is displayed in the form of a cubic model book three-dimensionally, wherein, the thickness of the cubic model book is alterable, and is proportional to the total value of pages of the PDF file. If a user need read a PDF file, he can turn the pages three-dimensionally by typing the page number to be turned to in the cubic model book, so as to turn to the page the user wants to reach. The thickness of page(s) which has/have been turned over in the cubic model book is proportional to the page number which has been turned to, and the thickness of page(s) which has/have not been turned over is proportional to a difference value calculated by subtracting the page number which has been turned to from the total value of the pages of the PDF file. Thus it can be seen that, the static presence sense in the form of the cubic model book and the dynamic sense of turning page(s) three-dimensionally can be experienced by the user. This technique has a good user interface, and a strong human-computer interaction sense, and thus has great attraction for the readers, so that it greatly improves the user experience of reading PDF files.

After the step 102, prior to the step 103, the method further comprising:

Step 102-1: Determining whether a virtual light source is demanded or not, if “yes”, then step 102-2 and step 102-3 are performed sequentially, otherwise step 103 is performed;

This step 102-1 is a determining step regarding setting the virtual light source. The prior art of display technology has supported creating a three-dimensional environment by means of setting a virtual light source (that is, not a real light source) in the display device.

Step 102-2: receiving position information of the virtual light source;

If the determination result at step 102-1 is “YES”, the user need set up a virtual light source, this step 102-2 is used to determine the position of the virtual light source inside the display device.

Step 102-3: Setting a virtual light source at the position indicated by the position information of the virtual light source, a light emitted from the virtual light source project onto the cubic model book, so that the cubic model book forms a shadow in the backlight direction.

After setting the virtual light source, the light emitted from the light source should be projected onto the cubic model book, otherwise the setting of the virtual light source is meaningless. In the case that the range occupied by the cubic model book is relatively large, the user can adjust the direction of light emitted from the virtual light source so as to light up a different position of the displayed page of the cubic model book.

When the light emitted by virtual light source light up the currently displayed page of the cubic model book, the light also forms a shadow in the backlight direction. In addition, the existence of the shadow further increases the three-dimensional sense of the cubic model book, so that the present invention would create more realistic three-dimension environment. Of course, the shape of the shadow should match the shape of the cubic model book.

Step 102-2 further comprising: receiving color information of the virtual light source; and thus, in the step 102-3, the color of the light of the virtual light source is determined according to the color information of the virtual light source.

It can be seen that, the present invention further sets color information of the virtual light source in step 102-2, thereby it determines the color of the light emitted from the virtual light source in step 102-3 based on the color information so as to make the color of the light emitted from the virtual light source adjustable, and to further enhance the user experience.

Step 102-2 further comprises: receiving illumination intensity information of the virtual light source; and thus, in the step 102-3, the light intensity emitted from the virtual light source is proportional to the illumination intensity information of the virtual light source.

The present invention can also set the illumination intensity information of the virtual light source, thereby it sets the intensity of the light emitted from the virtual light source information based on the illumination intensity information in step 102-3 so as to change the display contrast and improves the user experience.

Some PDF files come from scanning, so, all pages, or a part of pages are inclined, some characters in some PDF files are even upside down. Therefore, in order to ensure the user's reading effect, the present invention can also rotate the cubic model book, so that the characters on the displayed page become normal, and comply with the user's reading habits. Thus, in step 105, after a sub-step recited as: “after finishing turning page(s), a page in the PDF file is displayed, wherein, the page number of the displayed page in the PDF file is equal to the page number which has been turned to, and the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file”, the method further comprises the following sub-steps:

Sub-step 105-1: Determining whether it is demanded to rotate or not, if “yes”, then sub-step 105-2 and sub-step 105-3 are performed sequentially, otherwise there is not any operation;

This sub-step 105-1 is a step to provide a rotation requirement for the user, if the determination result is “YES”, the sequence or the order of current page arrangement does not match the user's reading habits, and the cubic model book is demanded to be rotated. Otherwise, if the determination result is “NO”, the cubic model book is not demanded to be rotated, and thus no operation should be taken.

Sub-step 105-2: receiving rotation angles to be rotated in each direction in a three-dimensional coordinate system;

The present invention rotates the cubic model book three-dimensionally, thus the rotation relates to the three-dimension coordinate system, wherein, the three-dimensional coordinate system may be a three-dimensional rectangular coordinate system, a three-dimensional polar coordinate system or any other arbitrary three-dimensional coordinate system.

There are three basic directions under the three-dimensional coordinate system, and these three directions orthogonal to each other, wherein, the rotation in one or two directions of these three directions does not affect the rotation in the other direction(s) of these three directions performed. Accordingly, in this sub-step 105-2, the cubic model book's rotation angles in each direction (that is angles of rotation)are demanded to be received in the three-dimensional coordinate system.

Sub-step 105-3: Rotating the cubic model book, so that, in the three-dimensional coordinate system, the cubic model book has been rotated angles in each direction which are equal to the rotation angles to be rotated in the same direction.

In this sub-step 105-3, the cubic model book is rotated in the three directions. Obviously, if the rotation angles in any one direction in sub-step 105-2 is zero, the cubic model book is not demanded to be rotated in that one direction.

The cubic model book is rotated in the three directions in the three-dimensional coordinate system, and what appears in front of the user is the three-dimensional rotation of the cubic model book. If the cubic model book is not rotated in the right place, and the user is still not satisfied with a result of the rotation after finishing one rotating round, then Sub-step 105-1 to Sub-step 105-3 are re-executed, and the cubic model book would be further rotated continuously, until the user are satisfied with a result of the rotation, and the result in the sub-step 105-1 is negative.

Thus, the present invention has the following advantages:

(1) In the present invention, the PDF file is displayed in the form of a cubic model book three-dimensionally, wherein, the thickness of the cubic model book is alterable, and is proportional to the total value of pages of the PDF file. If a user need read a PDF file, he can turn the pages three-dimensionally by typing the page number to be turned to in the cubic model book, so as to turn to the page the user wants to reach. The thickness of page(s) which has/have been turned over in the cubic model book is proportional to the page number which has been turned to, and the thickness of page(s) which has/have not been turned over is proportional to a difference value calculated by subtracting the page number which has been turned to from the total value of the pages of the PDF file. Thus it can be seen that, the static presence sense in the form of the cubic model book and the dynamic sense of turning page(s) three-dimensionally can be experienced by the user. This technique has a good user interface, and a strong human-computer interaction sense, and thus has great attraction for the readers, so that it greatly improves the user experience of reading PDF files.

(2) In the present invention, when the light emitted by the virtual light source light up the currently displayed page of the cubic model book, the light simultaneously also forms a shadow in the backlight direction. In addition, the existence of the shadow further increases the three-dimensional sense of the cubic model book, so that the present invention would create more realistic three-dimensional environment.

(3) The present invention further sets color information of the virtual light source, thereby it determines the color of the light emitted from the virtual light source based on the color information, so as to make the color of the light emitted from the virtual light source adjustable, and to further enhance the user experience.

The above-mentioned are only preferred embodiments of the present invention, and is not intended to limit the invention. Moreover, any modification, equivalent replacement, improvement, etc. within the spirit and principle of the present invention , should be deemed to be within the scope of the present invention.

What is claimed is:

1. A method for displaying a PDF file, comprising:
Step 1: extracting and obtaining a total value of pages of the PDF file;
Step 2: displaying a cubic model book corresponding to the PDF file three-dimensionally, so that the thickness of the cubic model book is proportional to the total value of pages of the PDF file;
Step 3: Determining whether it is demanded to turn pages of the PDF file or not, if “yes”, then step 4 and step 5 are performed sequentially, otherwise step 6 is performed;
Step 4: receiving a page number to be turned to;
Step 5: turning page(s) of the cubic model book three-dimensionally, so that: after finishing turning page(s), a page in the PDF file is displayed, wherein, the page number of the displayed page in the PDF file is equal to the page number which has been turned to, and the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file;
Step 6: Returning to Step 3.

2. The method as claimed in claim 1, wherein, after the step 2, and prior to the step 3, further comprising:
Step 2-1: Determining whether a virtual light source is demanded, if yes, then step 2-2 and step 2-3 are performed sequentially, otherwise step 3 is performed;
Step 2-2: receiving position information of the virtual light source;
Step 2-3: Setting a virtual light source at the position indicated by the position information of the virtual light source, a light emitted from the virtual light source project onto the cubic model book, so that the cubic model book forms a shadow in the backlight direction.

3. The method as claimed in claim 2, wherein, step 2-2, further comprising: receiving color information of the virtual light source; and thus,
In the step 2-3, the color of the light of the virtual light source is determined according to the color information of the virtual light source.

4. The method as claimed in claim 2, wherein, step 2-2, further comprising: receiving illumination intensity information of the virtual light source; and thus,
In the step 2-3, the light intensity emitted from the virtual light source is proportional to the illumination intensity information of the virtual light source.

5. The method as claimed in claim 1, wherein, in the step 5, after a sub-step recited as:
“after finishing turning page(s), a page in the PDF file is displayed, wherein, the page number of the displayed page in the PDF file is equal to the page number which has been turned to, and the thickness of page(s) which has/have been turned over in the cubic model book is proportional to the page number which has been turned to, and the thickness of page(s) which has/have not been turned over in the cubic model book is proportional to a difference value calculated by subtracting the page number which has been turned to from the total value of the pages of the PDF file”, the method further comprises the following sub-steps:
Sub-step 5-1: Determining whether it is demanded to rotate or not, if “yes”, then Sub-step 5-2 and Sub-step 5-3 are performed sequentially, otherwise there is not any operation;
Sub-step 5-2: receiving rotation angles to be rotated in each direction in a three-dimensional coordinate system;
Sub-step 5-3: Rotating the cubic model book, so that, in the three-dimensional coordinate system, the cubic model book has been rotated angles in each direction which are equal to the rotation angles to be rotated in the same direction.
